(19) United States
(12) Patent Application Publication
(10) Pub. No.: US 2025/0249617 A1
(43) Pub. Date: Aug. 7, 2025

(54) CUTTING DEVICE FOR PREVENTING FROM STICKING AND REMOVABLE CUTTER DEVICE

(71) Applicant: KYOUJIN INC., TAOYUAN CITY (TW)

(72) Inventor: SHIH-PING LEE, TAOYUAN CITY (TW)

(21) Appl. No.: 18/828,081

(22) Filed: Sep. 9, 2024

(30) Foreign Application Priority Data
Feb. 7, 2024 (TW) 113105005

(51) Int. Cl. B26D 7/26; B26D 7/02

(52) U.S. Cl. CPC B26D 7/2614; B26D 7/025

(57) ABSTRACT

A cutting device for preventing from sticking includes a base module and a cutter set. A portion of at least one of two opposite movable cutter surfaces of the movable cutter is recessed inward to form at least one movable cutter recess. The movable cutter is configured to move closer to or away from a fixed cutter along a first direction. When the movable cutter moves along the first direction, the movable cutter recess is configured to prevent papers from sticking to the movable cutter.

### BACKGROUND

### Field of Invention

The present disclosure relates to a removable cutter device, a cutting device with a paper clamping mechanism and a cutting device for preventing from sticking.

### Description of Related Art

Traditional cutter devices have some defects. For example, sticky materials of papers may stick to a side of a cutter such that the cut size of the papers may be inaccurate. Moreover, it is difficult to detach the cutter from a cutter set, and a pitch between a cutter and a roller is too far.

### SUMMARY

According to an embodiment of the present disclosure, a cutting device for preventing from sticking is configured to cut a paper, and the cutting device for preventing from sticking includes a base module and a cutter set. The base module has a first fixed portion and a second fixed portion opposite to the first fixed portion. A motor and a movable cutter are disposed between the first fixed portion and the second fixed portion, and a portion of at least one of two opposite movable cutter surfaces of the movable cutter is recessed inward to form at least one movable cutter recess. A cutter set is connected to the first fixed portion and the second fixed portion and having a fixed cutter. The movable cutter is configured to move closer to or away from the fixed cutter in a first direction. When the movable cutter moves along the first direction, the at least one movable cutter recess is configured to prevent the paper from sticking to the movable cutter. A length direction of the movable cutter and the fixed cutter is a second direction, and the first direction is perpendicular to the second direction.

According to an embodiment of the present disclosure, a removable cutter device includes a bracket module, an upper cover module and a replaceable cutter module. The bracket module has a first side wall and a second side wall opposite to the first side wall. The second side wall has a cutter exit button. The upper cover module is located on the bracket module and has a first cutter. The first cutter has a first blade portion. The replaceable cutter module is located between the first side wall and the second side wall and has a second cutter and at least one buckling point. The second cutter has a second blade portion. The at least one buckling point is fastened to at least one of the first side wall and the second side wall. When the cutter exit button of the bracket module is pressed, the replaceable cutter module pops out from the second side wall such that the replaceable cutter module rotates with the at least one buckling point as an axis along a direction moving away from the first side wall and the second side wall.

According to an embodiment of the present disclosure, a removable cutter device includes a bracket module, an upper cover module, a replaceable cutter module and a conveying module. The bracket module has a first side wall and a second side wall opposite to the first side wall. The upper cover module is located on the bracket module and having a first cutter. The replaceable cutter module is located on the bracket module and has a second cutter. The second cutter has a blade portion. The conveying module has a first roller and a second roller. The first roller and the second roller are rotatably disposed between the first side wall and the second side wall. The first roller is parallel to the second roller in a horizontal direction. The first roller is disposed adjacent to the blade portion. A pitch is located between the first roller and the blade portion, and the pitch is in a range from 0.1 mm to 2 mm.

According to an embodiment of the present disclosure, a cutting device with a paper clamping mechanism includes a bracket module, a conveying module, a cutter module and a clamping module. The conveying module is disposed on the bracket module and conveys a continuous sheet material along a first direction. The cutter module includes a fixed cutter and a movable cutter. The fixed cutter is fixed on the bracket module and extends along a second direction. The movable cutter is disposed on the bracket module and is parallel to the fixed cutter. The movable cutter extends along a third direction to move closer to or move away from the fixed cutter. The first direction, the second direction and the third direction are orthogonal to each other. The movable cutter includes a first cutter body and a first blade portion formed on an edge of the first cutter body. The fixed cutter includes a second cutter body and a second blade portion formed on the second cutter body. The clamping module includes a first clamping portion disposed on the first cutter body and a second clamping portion disposed on the second cutter body. When the movable cutter moves along the third direction, the first clamping portion abuts to the second clamping portion to clamp the continuous sheet material. The cutter module further includes a position sensor near to the fixed cutter to detect the continuous sheet material. When the position sensor detects the continuous sheet material, the movable cutter moves closer to the fixed cutter. When the position sensor does not detect the continuous sheet material, the movable cutter moves away from the fixed cutter.

### BRIEF DESCRIPTION OF THE DRAWINGS

FIG. 1 illustrates a front view of a cutting device for preventing from sticking according to one embodiment of the present disclosure, in which a housing of a base module is omitted.

FIG. 2 illustrates a fixed cutter according to one embodiment of the present disclosure.

FIG. 3 illustrates a movable cutter according to one embodiment of the present disclosure.

FIG. 4A illustrates a stereoscopic view of an upper cover module of a removable cutter device according to one embodiment of the present disclosure.

FIG. 4B illustrates an enlarged view of the removable cutter device of FIG. 4A.

FIG. 5 illustrates a schematic view that a replaceable cutter module is rotated according to one embodiment of the present disclosure.

FIG. 6 illustrates a schematic view of a pitch located between a first roller and a second blade portion according to one embodiment of the present disclosure.

FIG. 7 illustrates a schematic view that a first roller is detached from a bracket module according to one embodiment of the present disclosure.

FIG. 8 illustrates a schematic view that a head piece exit button and a head piece element are operated according to one embodiment of the present disclosure.

FIG. 9 illustrates a stereoscopic view that a movable cutter of a cutter module is cut with a fixed cutter according to one embodiment of the present disclosure.

FIG. 10 illustrates a schematic view that a clamping module of a cutting device with a paper clamping mechanism clamps a continuous sheet material according to one embodiment of the present disclosure.

FIG. 11 illustrates a stereoscopic view of a cutter module and a clamping module of a cutting device with a paper clamping mechanism according to one embodiment of the present disclosure.

### DETAILED DESCRIPTION

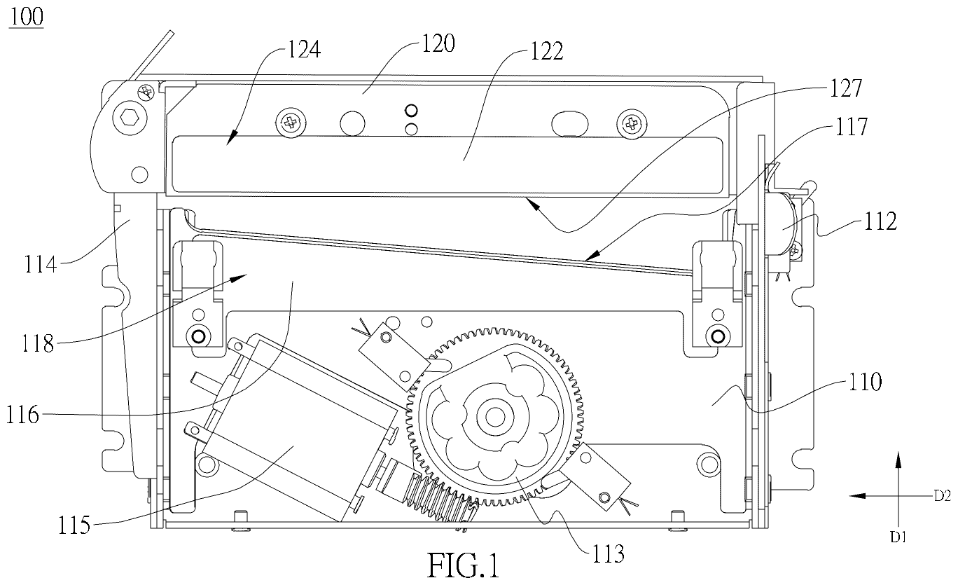

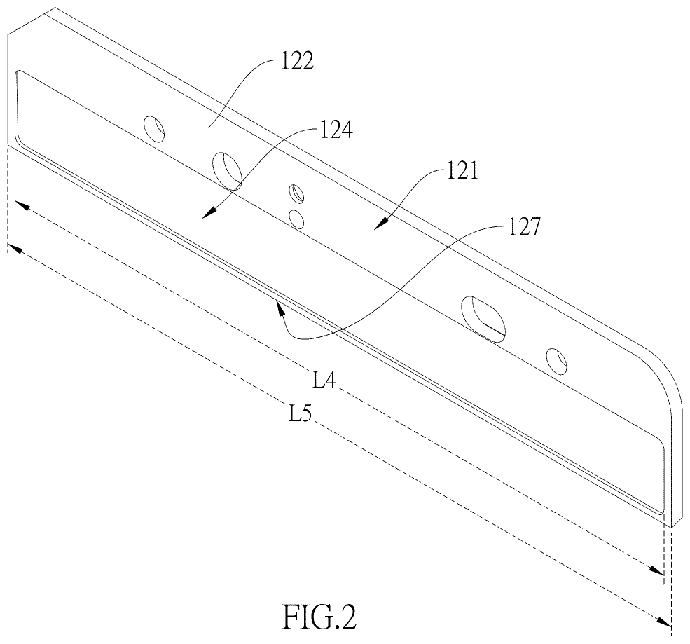

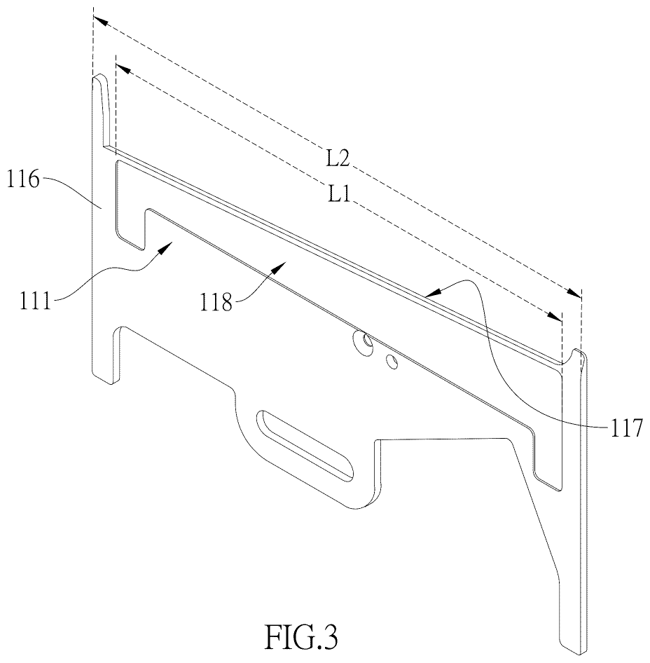

Referring to FIG. 1 to FIG. 3, FIG. 1 illustrates a front view of a cutting device for preventing from sticking 100 according to one embodiment of the present disclosure, in which a housing of a base module 110 is omitted, FIG. 2 illustrates a fixed cutter 122 according to one embodiment of the present disclosure. FIG. 3 illustrates a movable cutter 116 according to one embodiment of the present disclosure. The cutting device for preventing from sticking 100 is configured to cut a paper A. A base module 110 has a first fixed portion 112 and a second fixed portion 114 opposite to the first fixed portion 112. A motor 115 and the movable cutter 116 is located between the first fixed portion 112 and the second fixed portion 114. A portion of two opposite movable cutter surfaces 111 of the movable cutter 116 is recessed inward to form a movable cutter recess 118. The cutter set 120 is connected to the first fixed portion 112 and the second fixed portion 114 and has the fixed cutter 122. The movable cutter 116 is configured to move closer to or move away from the fixed cutter 122 along a first direction D1. When the movable cutter 116 moves along the first direction D1, the movable cutter recess 118 is configured to prevent the paper A from sticking to the movable cutter 116. A length direction of the movable cutter 116 and the fixed cutter 122 is a second direction D2. The first direction D1 is perpendicular to the second direction D2. In the first direction D1, the movable cutter recess 118 of the movable cutter 116 of the base module 110 is configured to avoid the movable cutter 116 sticking to the paper A such that the operator does not need to remove the paper A from a side of the movable cutter 116, which can reduce the repeated removal of the paper A to improve the operator's working speed.

The movable cutter recess 118 of the movable cutter 116 may prevent the sticky material of the paper A from contacting to a side of the movable cutter 116, which may avoid insufficient adhesion of the paper A during subsequent application and may improve the sticky quality of the manufactured paper A. The two movable cutter recesses 118 are respectively formed in the two movable cutter surfaces 111 of the movable cutter 116. Or, the one movable cutter recess 118 is only formed in the one movable cutter surface 111 of the movable cutter 116, and the one movable cutter surface 111 which the one movable cutter recess 118 is formed faces away from the motor 115. Or, the one movable cutter recess 118 is only formed in one of the two movable cutter surfaces 111 of the movable cutter 116.

A portion of at least one of two opposite fixed cutter surfaces 121 of the fixed cutter 122 is recessed inward to form at least one fixed cutter recess 124. Or, the one fixed cutter recess 124 is only formed in the one fixed cutter surface 121 of the fixed cutter 122, and the one fixed cutter surface 121 which the one fixed cutter recess 124 is formed faces away from the motor 115. The fixed cutter recess 124 is configured to prevent the paper A from sticking to the fixed cutter 122. The fixed cutter recess 124 are respectively formed in the two fixed cutter surfaces 121. The one fixed cutter recess 124 is only formed on one of the two fixed cutter surfaces 121 of the fixed cutter 122. One end close to the fixed cutter 122 of the cutter set 120 of the movable cutter 116 of the base module 110 has a first blade portion 117.

The movable cutter recess 118 of the movable cutter 116 of the base module 110 is adjacent to the first blade portion 117 of the movable cutter 116 of the base module 110. In a second direction D2 (such as a horizontal direction), the motor 115 is located between the first fixed portion 112 and the second fixed portion 114 of the base module 110. The motor 115 is pivotally connected to a rotating element 113. The rotating element 113 may be configured to drive the movable cutter 116 of the base module 110 to move toward or move away from the fixed cutter 122 of the cutter set 120 along the first direction D1. One end close to the movable cutter 116 of the base module 110 of the fixed cutter 122 of the cutter set 120 has a second blade portion 127. The fixed cutter recess 124 of the fixed cutter 122 of the cutter set 120 is adjacent to the second blade portion 127. The motor 115 may activate the rotating element 113, and the rotating element 113 may allow the movable cutter 116 of the base module 110 to rise along the first direction D1 to approach the fixed cutter 122 of the cutter set 120.

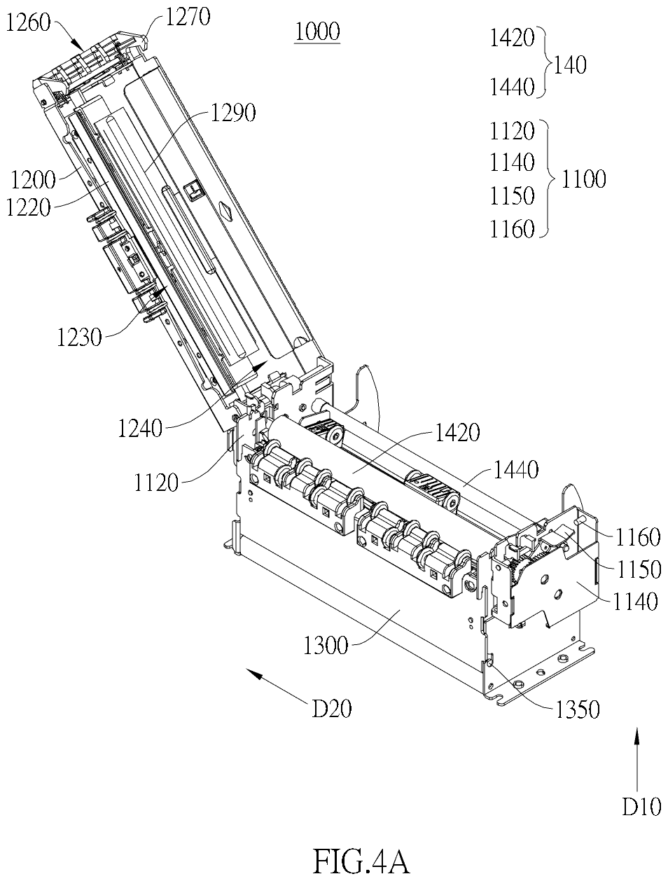

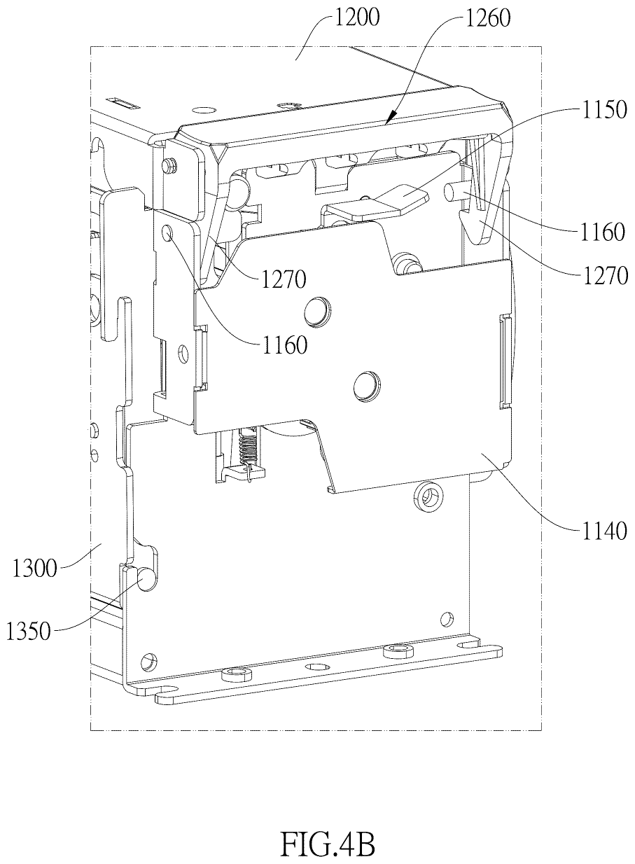

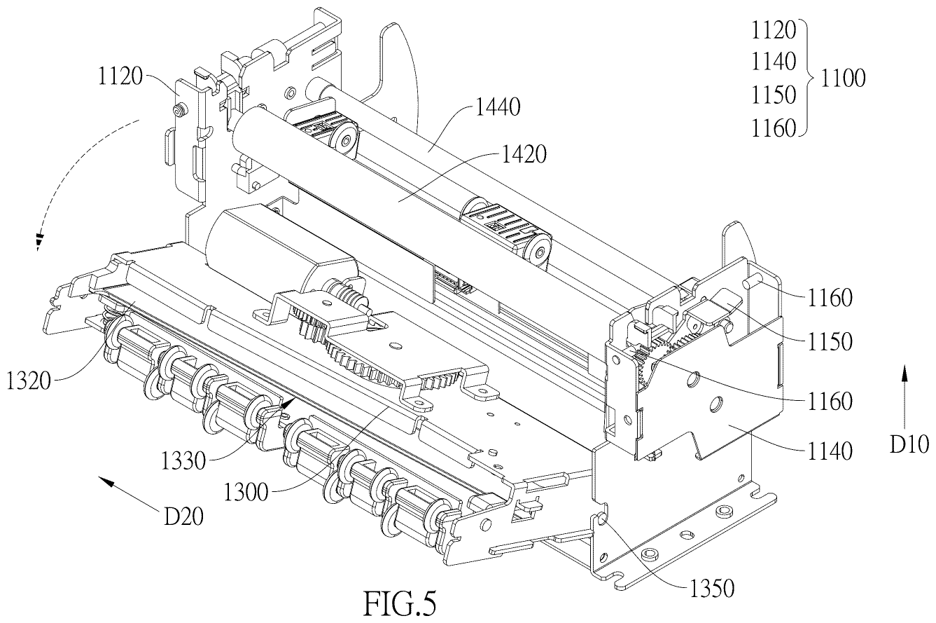

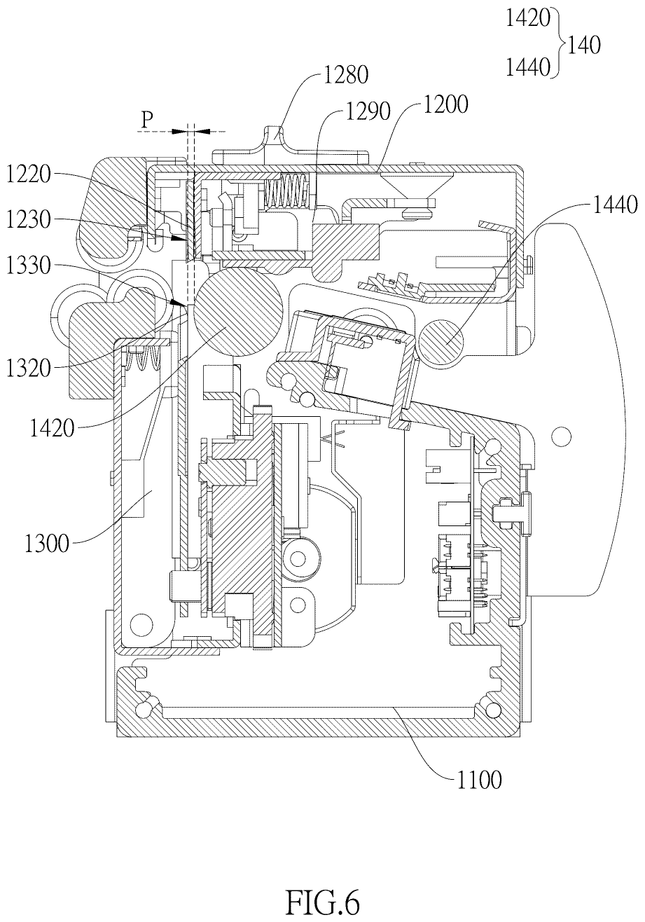

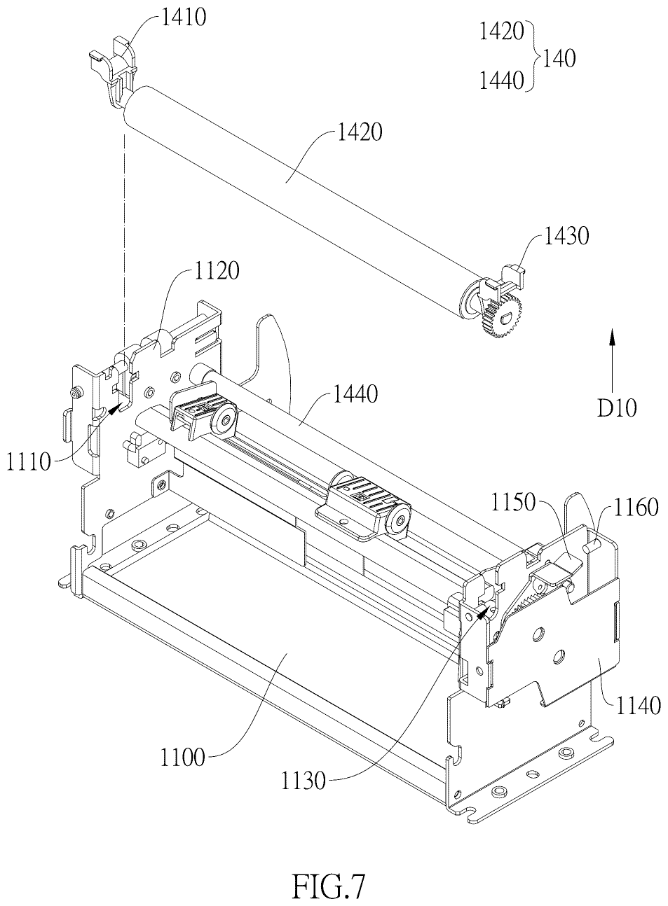

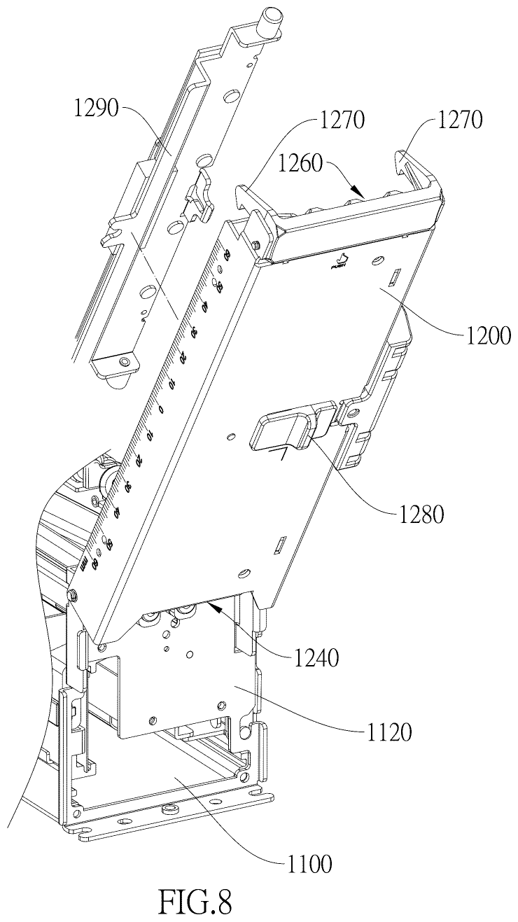

Referring to FIG. 4A to FIG. 8, FIG. 4A illustrates a stereoscopic view of an upper cover module 1200 of a removable cutter device 1000 according to one embodiment of the present disclosure, FIG. 4B illustrates an enlarged view of the removable cutter device 1000 of FIG. 4A, FIG. 5 illustrates a schematic view that a replaceable cutter module 1300 is rotated according to one embodiment of the present disclosure, FIG. 6 illustrates a schematic view of a pitch P located between a first roller 1420 and a second blade portion 1330 according to one embodiment of the present disclosure, FIG. 7 illustrates a schematic view that the first roller 1420 is detached from the bracket module 1100 according to one embodiment of the present disclosure, and FIG. 8 illustrates a schematic view that a head piece exit button 1280 and a head piece element 1290 are operated according to one embodiment of the present disclosure.

The bracket module 1100 has a first side wall 1120 and a second side wall 1140 opposite to the first side wall 1120. The second side wall 1140 of the bracket module 1100 has a cutter exit button 1150. The upper cover module 1200 is detachably disposed on the bracket module 1100. The upper cover module 1200 has a first cutter 1220. The first cutter 1220 of the upper cover module 1200 has a first blade portion 1230. The replaceable cutter module 1300 is disposed between the first side wall 1120 and the second side wall 1140 of the bracket module 1100 and has a second cutter 1320 and buckling points 1350. The buckling points 1350 are located on both sides of the replaceable cutter module 1300. The number of the buckling points 1350 may be two, and the two buckling points 1350 may be respectively located on both sides of the replaceable cutter module 1300. The second cutter 1320 of the replaceable cutter module 1300 has a second blade portion 1330.

The buckling points 1350 of the replaceable cutter module 1300 are buckled to the first side wall 1120 and the second side wall 1140 of the bracket module 1100. After the replaceable cutter module 1300 is rotated with the buckling points 1350 as the axis in a direction away from the first side wall 1120 and the second side wall 1140 of the bracket module 1100, the buckling points 1350 of the replaceable cutter module 1300 may be configured to be detached from at least one of the first side wall 1120 and the second side wall 1140 of the bracket module 1100, so that the replaceable cutter module 1300 may be removed from the bracket module 1100. When the cutter exit button 1150 of the bracket module 1100 of the removable cutter device 1000 is pressed, the replaceable cutter module 1300 may be ejected from the second side wall 1140 of the bracket module 1100, so that the replaceable cutter module 1300 may rotate with the buckling point 1350 as an axis in a direction away from the first side wall 1120 and the second side wall 1140 of the bracket module 1100. The replaceable cutter module 1300 may be detached from the bracket module 1100 to improve the situation that traditional cutting devices is required to detach most parts before the cutter is detached, which may improve an efficiency of an operator's efficiency while replacing cutter and may reduce overall operating time.

The first side 1240 of the upper cover module 1200 is pivotally connected to the first side wall 1120 of the bracket module 1100. The first side 1240 of the upper cover module 1200 may rotate opposite to the first side wall 1120 of the bracket module 1100. The second side wall 1140 of the bracket module 1100 has a cylindrical buckle 1160. The cylindrical buckle 1160 of the bracket module 1100 is configured to buckle a buckle portion 1270 of the second side 1260 of the upper cover module 1200 with the second side wall 1140 of the bracket module 1100. The cylindrical buckle 1160 of the bracket module 1100 may release the second side 1260 of the upper cover module 1200 so that the second side 1260 of the upper cover module 1200 is detached from the second side wall 1140 of the bracket module 1100.

The replaceable cutter module 1300 may be configured to move the second cutter 1320 in a vertical direction D10 to make the second blade portion 1330 of the second cutter 1320 move close to or move away from the first blade portion 1230 of the first cutter 1220. The first roller 1420 and the second roller 1440 of the conveying module 1400 are rotatably disposed between the first side wall 1120 and the second side wall 1140 of the bracket module 1100. The first roller 1420 of the conveyor module 1400 is disposed between the second cutter 1320 of the replaceable cutter module 1300 and the second roller 1440 of the conveyor module 1400. The first roller 1420 of the conveying module 1400 is disposed adjacent to the second blade portion 1330 of the second blade 1320 of the replaceable blade module 1300.

In a horizontal direction D20, The pitch P is located between the first roller 1420 of the conveying module 1400 and the second blade portion 1330 of the second cutter 1320, and the pitch P is in a range from 0.1 mm to 2 mm. That is, the first roller 1420 of the conveying module 1400 and the second blade portion 1330 of the second cutter 1320 are only separated from 0.1 mm to 2 mm. The first roller 1420 of the conveying module 1400 has a first buckle 1410 and a second buckle 1430 opposite to the first buckle 1410. The first side wall 1120 of the bracket module 1100 has a first groove 1110. The second side wall 1140 of the bracket module 1100 has a second groove 1130. The first buckle 1410 of the first roller 1420 is configured to be disposed in the first groove 1110 of the first side wall 1120, and the second buckle 1430 of the first roller 1420 is configured to be disposed in the first groove 1110 of the second side wall 1140. The first buckle 1410 and the second buckle 1430 of the first roller 1420 of the conveyor module 1400 are detachably disposed in the first groove 1110 of the first side wall 1120 and the second groove 1130 of the second side wall 1140. The upper cover module 1200 has the head piece exit button 1280 and the head piece element 1290. The head piece element 1290 of the upper cover module 1200 is buckled on the upper cover module 1200. When the head piece exit button 1280 of the upper cover module 1200 is pressed, the head piece element 1290 of the upper cover module 1200 may be detached from the upper cover module 1200 to replace the head piece 1290.

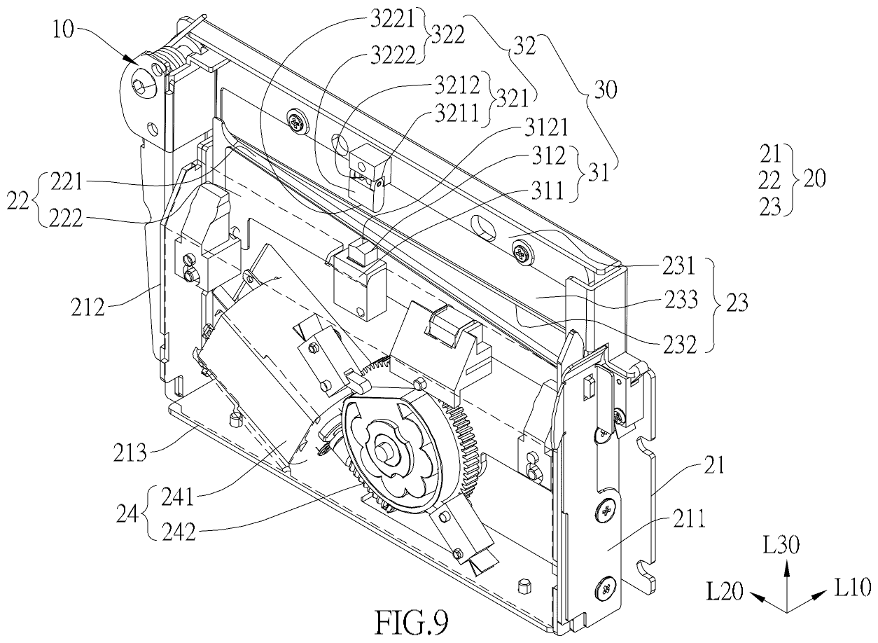

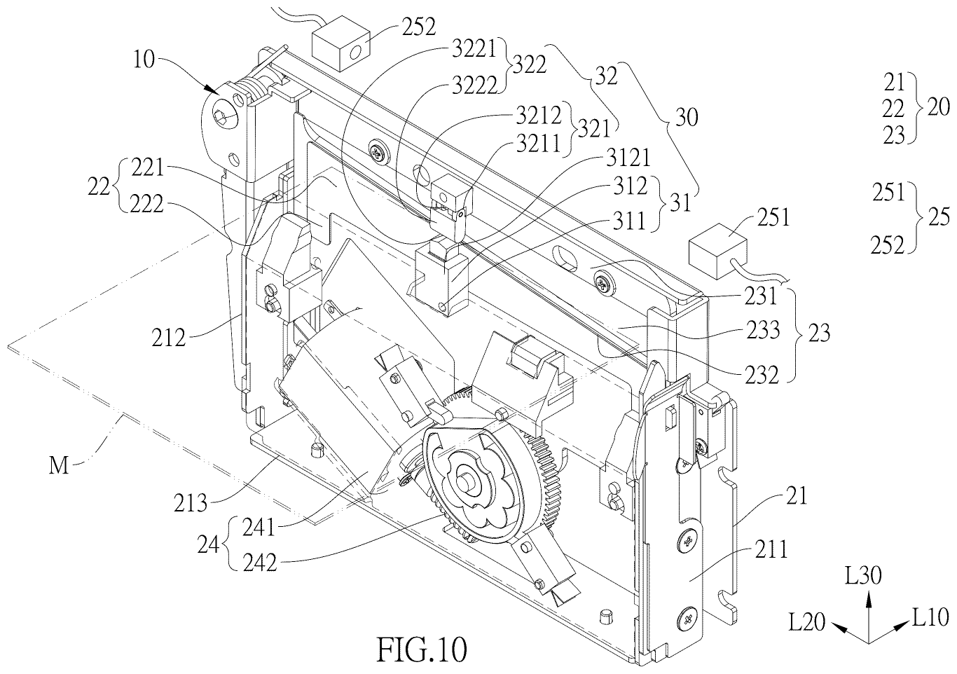

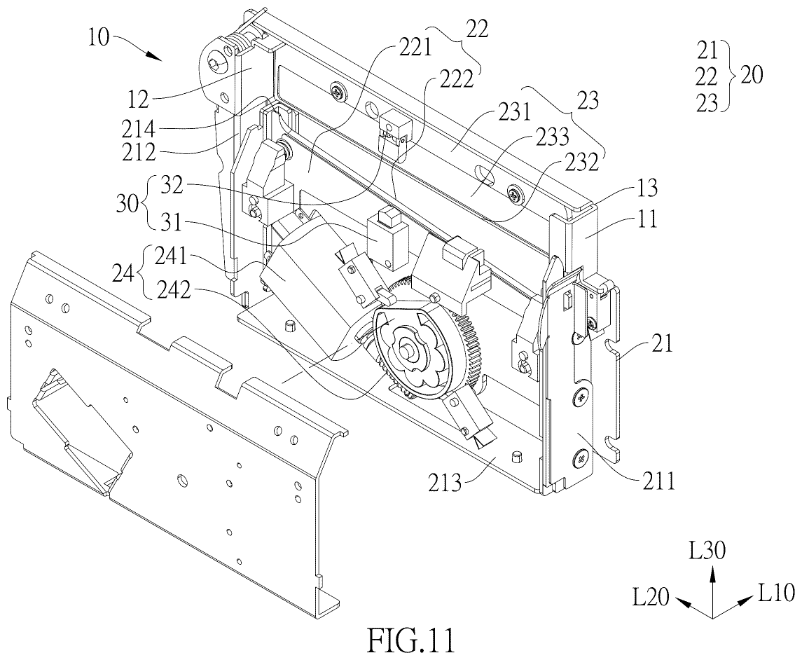

Referring to FIG. 9 to FIG. 11, FIG. 9 illustrates a stereoscopic view that a movable cutter 22 of a cutter module 20 is cut with a fixed cutter 23 according to one embodiment of the present disclosure, FIG. 10 illustrates a schematic view that a clamping module 30 of a cutting device with a paper clamping mechanism clamps a continuous sheet material M according to one embodiment of the present disclosure, and FIG. 11 illustrates a stereoscopic view of the cutter module 20 and the clamping module 30 of the cutting device with the paper clamping mechanism according to one embodiment of the present disclosure. A conveying module is disposed on the bracket module 10 and conveys the continuous sheet material M along a first direction L10. The bracket module 10 includes a first side wall 11, a second side wall 12 opposite to the first side wall 11, and a support wall 13 connected to the first side wall 11 and the second side wall 12. The support wall 13 extends along a second direction L20. The cutter module 20 includes a cutter holder 21, a movable cutter 22 and a fixed cutter 23. The cutter holder 21 is adjacent to the bracket module 10 and detachably combined with the bracket module 10. The cutter holder 21 includes a third side wall 211, a fourth side wall 212, and a bottom wall 213 connected to the third side wall 211 and the fourth side wall 212. The bottom wall 213 extends along the second direction L20 and a normal direction of the bottom wall 213 is perpendicular to the first direction L10.

The clamping module 30 includes a first clamping portion 31 disposed on the first cutter body 221 and a second clamping portion 32 disposed on the second tool body 231. When the movable cutter 22 moves along a third direction L30, the first clamping portion 31 abuts to the second clamping portion 32 to clamp the continuous sheet material M. The cutter module 20 further includes a position sensor 25. The position sensor 25 is disposed close to the fixed cutter 23 and located outside the cutting cutter device with a paper clamping mechanism. The position sensor 25 is configured to detect the continuous sheet material M. When the position sensor 25 detects the continuous sheet material M, the movable cutter 22 moves toward the fixed cutter 23. When the position sensor 25 does not detect the continuous sheet material M, the movable cutter 22 moves away from the fixed cutter 23.

When infrared rays emitted by a transmitting end 251 of the position sensor 25 are not received by a receiving end 252, it indicates that the continuous sheet material M is located outside the fixed cutter 23, and the movable cutter 22 moves to the fixed cutter 23. When the continuous sheet material M is cut and removed, the infrared rays emitted by the transmitting end 251 of the position sensor 25 may be received by the receiving end 252, such that the movable cutter 22 moves along an opposite direction and is reset to prepare for the next cutting operation.

What is claimed is:

1. A cutting device for preventing from sticking configured to cut a paper, the cutting device for preventing from sticking comprising:
a base module having a first fixed portion and a second fixed portion opposite to the first fixed portion, wherein a motor and a movable cutter are disposed between the first fixed portion and the second fixed portion, and a portion of at least one of two opposite movable cutter surfaces of the movable cutter is recessed inward to form at least one movable cutter recess; and
a cutter set connected to the first fixed portion and the second fixed portion and having a fixed cutter, wherein the movable cutter is configured to move closer to or away from the fixed cutter in a first direction, when the movable cutter moves along the first direction, the at least one movable cutter recess is configured to prevent the paper from sticking to the movable cutter, a length direction of the movable cutter and the fixed cutter is a second direction, and the first direction is perpendicular to the second direction.

2. The cutting device for preventing from sticking of claim 1, wherein the two movable cutter recesses are respectively formed in the two movable cutter surfaces of the movable cutter.

3. The cutting device for preventing from sticking of claim 1, wherein the at least one movable cutter recess is only formed in the one movable cutter surface of the movable cutter, and the one movable cutter surface which the at least one movable cutter recess is formed faces away from the motor.

4. The cutting device for preventing from sticking of claim 1, wherein a portion of at least one of two opposite fixed cutter surfaces of the fixed cutter is recessed inward to form at least one fixed cutter recess, and when the movable cutter moves along the first direction, the at least one fixed cutter recess is configured to prevent the paper from sticking to the fixed cutter.

5. The cutting device for preventing from sticking of claim 4, wherein the at least one fixed cutter recess is only formed in the one fixed cutter surface of the fixed cutter, and the one fixed cutter surface which the at least one fixed cutter recess is formed faces away from the motor.

6. A removable cutter device, comprising:
a bracket module having a first side wall and a second side wall opposite to the first side wall, wherein the second side wall has a cutter exit button;
an upper cover module located on the bracket module and having a first cutter, wherein the first cutter has a first blade portion; and
a replaceable cutter module located between the first side wall and the second side wall and having a second cutter and at least one buckling point, wherein the second cutter has a second blade portion, the at least one buckling point is fastened to at least one of the first side wall and the second side wall, and when the cutter exit button of the bracket module is pressed, the replaceable cutter module pops out from the second side wall such that the replaceable cutter module rotates with the at least one buckling point as an axis along a direction moving away from the first side wall and the second side wall.

7. The removable cutter device of claim 6, wherein the upper cover module has a first side and a second side opposite to each other, the first side is pivotally connected to the first side wall of the bracket module, the second side wall of the bracket module has two cylindrical clips, and the cylindrical clips are configured to fasten a buckle portion of the second side of the upper cover module to the second side wall of the bracket module.

8. The removable cutter device of claim 6, wherein the upper cover module is detachably disposed on the bracket module, the replaceable cutter module is detachably disposed between the first side wall and the second side wall, after the replaceable cutter module rotates with the at least one buckling point as the axis along the direction moving away from the first side wall and the second side wall, the at least one buckling point of the replaceable cutter module is configured to disengage from at least one of the first side wall and the second side wall to allow the replaceable cutter module to be removed from the bracket module.

9. The removable cutter device of claim 6, further comprising:
a conveying module having a first roller and a second roller, wherein the first roller and the second roller are rotatably disposed between the first side wall and the second side wall, the first roller is parallel to the second roller in a horizontal direction, the first roller is disposed adjacent to the second blade portion, a pitch is located between the first roller and the second blade portion, and the pitch is in a range from 0.1 mm to 2 mm.

10. A removable cutter device, comprising:
a bracket module having a first side wall and a second side wall opposite to the first side wall;
an upper cover module located on the bracket module and having a first cutter;
a replaceable cutter module located on the bracket module and having a second cutter, wherein the second cutter has a blade portion; and
a conveying module having a first roller and a second roller, wherein the first roller and the second roller are rotatably disposed between the first side wall and the second side wall, the first roller is parallel to the second roller in a horizontal direction, the first roller is disposed adjacent to the blade portion, a pitch is located between the first roller and the blade portion, and the pitch is in a range from 0.1 mm to 2 mm.

11. The removable cutter device of claim 10, wherein a first buckle and a second buckle are respectively located on two opposite sides of the first roller, the first side wall has a first groove, the second side wall has a second groove, the first buckle is configured to be disposed in the first groove, the second buckle is configured to be disposed in the second groove, and the first buckle and the second buckle of the first roller are detachably disposed in the first groove and the second groove.

12. The removable cutter device of claim 10, wherein the upper cover module has a head piece exit button and a head piece element, the head piece element is fastened to the upper cover module, and when the head piece exit button is pressed, the head piece element is detached from the upper cover module.
